(19) United States
(12) Patent Application Publication
(10) Pub. No.: US 2006/0049915 A1
(43) Pub. Date: Mar. 9, 2006

(54) USB port incorporated into vehicle access components

(75) Inventors: Jean-Christophe Deniau, Fenton, MI (US); Mark Dean Wallace, White Lake, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/216,908

(22) Filed: Aug. 31, 2005

Related U.S. Application Data
(60) Provisional application No. 60/607,400, filed on Sep. 3, 2004.

(51) Int. Cl. B60R 25/00; G05B 19/00

(52) U.S. Cl. 340/5.72; 340/5.64; 340/426.36; 701/29

(57) ABSTRACT

A remote keyless entry component is provided with a USB connector such that it can be plugged into a docking station on a vehicle, or into a user's home computer. In this manner, diagnostic information may be stored on the remote keyless entry component, and then transmitted over the internet to a maintenance facility. The present invention thus provides additional power and functionality to be incorporated into a remote keyless entry component.

The application claims priority to U.S. Provisional Application No. 60/607,400, which was filed on Sep. 3, 2004.

### BACKGROUND OF THE INVENTION

This application relates to a component to provide remote access into a vehicle, wherein the component is also provided with a USB (universal serial bus) port such that it can easily interface with a docking port on the vehicle, and also with a computer located away from the vehicle.

Vehicles are being provided with more and more electronic components and diagnostic information. Typically, vehicles are provided with a computer that communicates with various components over an information bus. The computer can generate diagnostic information that can be sent to maintenance personnel, or to the owner of the vehicle in various ways. Typically, there is no easy way to communicate this information to a remote maintenance site, however.

In addition, vehicles are being provided with remote keyless entry systems. These systems allow a user to actuate a switch when approaching the vehicle to provide access to the vehicle. The remote keyless entry systems have been utilized to provide various other functions, however, they have not been utilized to provide any additional diagnostic function.

### SUMMARY OF THE INVENTION

In a disclosed embodiment of this invention, a remote keyless entry transmitter is provided with a USB connector. This connector allows the remote keyless entry component to be mounted within a docking station on the vehicle, at which it can communicate with the computer on the vehicle. In addition, the remote keyless entry component can be plugged into a user's home computer. As one example of the power provided by this invention, the computer on the vehicle can provide diagnostic information to be stored on the remote keyless entry component. The remote keyless entry component can then be plugged into the user's home computer, and that diagnostic information can then be transmitted over the internet to a maintenance location such as a car dealership. In this manner, the maintenance location can provide diagnostic analysis of the information on the car, and can prepare for maintenance when the car is brought to the dealership.

In a disclosed embodiment, the remote keyless entry system has a cover that snaps over the USB connector to protect the connector. In addition, an optional memory stick can be placed on the remote keyless entry component.

These and other features of the present invention can be best understood from the following specification and drawings, the following of which is a brief description.

### BRIEF DESCRIPTION OF THE DRAWINGS

FIG. 1 a schematic view of a system incorporating the present invention.

FIG. 2 is a schematic of the remote keyless entry component.

FIG. 3 is a schematic of a docking station on a vehicle.

### DETAILED DESCRIPTION OF THE PREFERRED EMBODIMENT

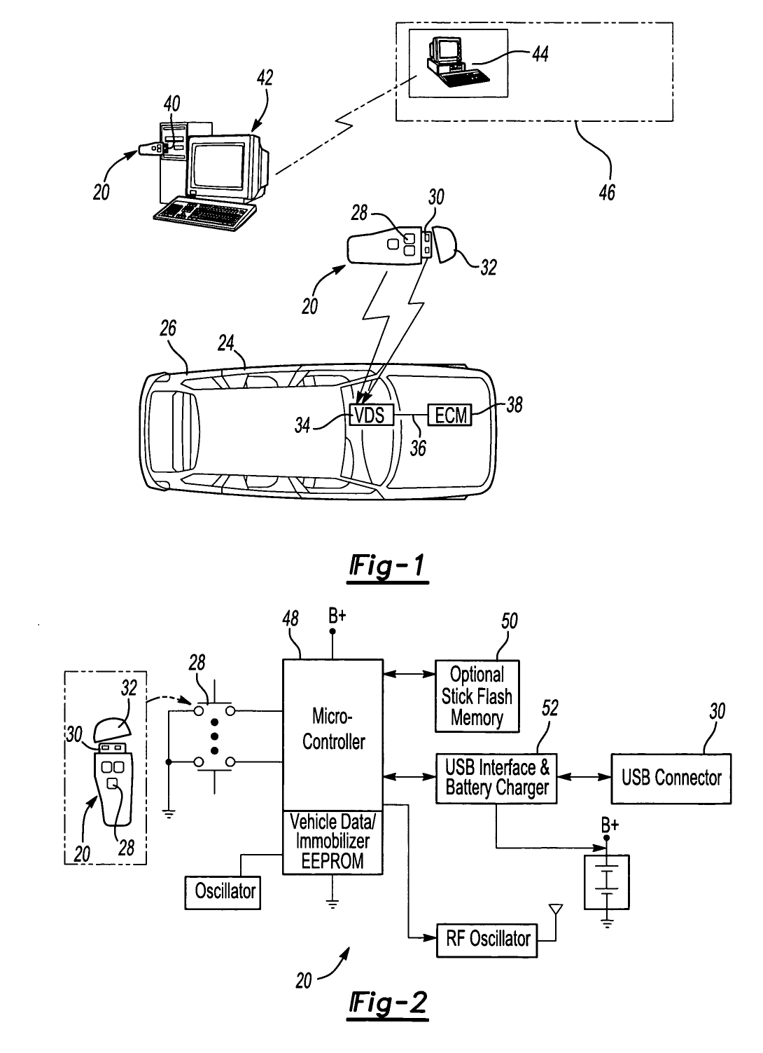

FIG. 1 shows a remote keyless entry component 20 for providing access to doors 24 on a vehicle 26, or to the trunk, etc. As is known, switches 28 on the remote keyless entry component 20 are actuated to provide access or unlock the doors/trunk, etc.

The present invention is directed to providing a USB connector 30 on the remote keyless entry component 20. As shown, a cap 32 can be removed, or can be left on the connector to protect the connector when the remote keyless entry component 20 is being utilized outside of the vehicle.

When the cover 32 is removed, the connector 30 can be plugged into a docking station 34 on the vehicle. The docking station provides access over a bus 36 to the electronic control module 38 on the vehicle 26.

The electronic control module can communicate with the remote keyless entry component, and can store information on the remote keyless entry component 20. As an example, diagnostic information can be stored.

In addition, the remote keyless entry component 20 includes the ability to communicate within an immobilizer system associated with the electronic control module 38 or the vehicle ignition. This aspect of the invention is as known.

As mentioned, the electronic control module 38 may provide diagnostic information that is stored on the remote keyless entry component 20. The connector 30 can then be plugged into a port 40 on a home computer 42. This home computer 42 can now communicate over the internet with a computer 44 at a remote location such as a car dealership 46. The car dealership 46 can now provide analysis of the diagnostic information, and can be better prepared for maintenance on the vehicle when the vehicle eventually reaches the car dealership 46.

FIG. 2 shows the remote keyless entry component 20 having the switches 28, the connector 30, and the cover 32. The schematic portion shows that the remote keyless entry component 20 has a microcontroller 48, and an optional stick flash memory 50. Dependent on the amount of information that is to be stored, the memory may or may not be utilized.

The USB connector 30 communicates with an interface and battery charger 52.

The battery is preferably sealed within the body of the remote keyless entry component 20. The battery can be recharged either from the vehicle docking port 34, or from the home computer.

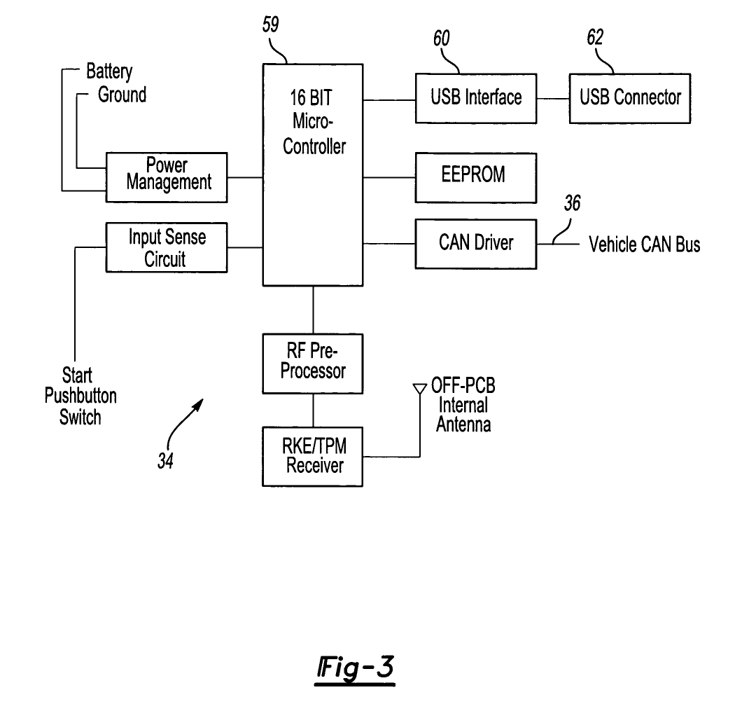

FIG. 3 shows the docking port 34, including a connector 62, an interface 60, and a microcontroller 59. The microcontroller 59 communicates to the vehicle bus 36.

As mentioned, the immobilization function is also provided over this hard connection of the remote keyless entry component 20 when it is plugged into the docking port 34. The general functionality of the immobilization function may be as known. The remote keyless entry component may have an initial seed key at the time of manufacture, and may be programmed to the vehicle when plugged into the docking port.

The remote keyless entry component 20 preferably has enough memory to store items such as the VIN (vehicle identification number), diagnostic trouble codes, odometer reading, vehicle battery status, last regular maintenance (oil change, etc.). All of this information could be uploaded and updated into the remote keyless entry component during vehicle operation via the bus. Also, the optional memory stick may provide additional memory. There may be a standard 128M of memory, with an additional capacity of 128M provided by the memory stick. Of course, other than packaging restraints, more memory can be included. The optional/additional memory provides greater storage for file transfer functions as mentioned above.

A mechanical key may be incorporated into the remote keyless entry system.

The docking station 34 will preferably lock the remote keyless entry component into the docking station while the vehicle is out of park, and after the immobilization handshake has been completed. Thus, when the vehicle is out of park, the remote keyless entry component 20 will not be removable. Further, a push button start switch may be incorporated, and as shown in FIG. 3 is incorporated into the docking station 34. This push button start switch allows the starting of the vehicle to occur with an electronic actuation.

The present invention thus provides additional power in the use of a remote keyless entry system to supplement the diagnostic information that is already provided on a vehicle, but which is not always easily transmitted from the vehicle to maintenance personnel. The present invention thus improves upon the prior art.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A remote keyless entry component comprising:
a plurality of switches to actuate signals to be transmitted to a vehicle to provide at least the function of unlocking a door on the vehicle, and a transmitter for transmitting said signals from a location remote from said vehicle; and
said remote keyless entry component having a connector for connecting said remote keyless entry component into a computer.

2. The remote keyless entry component as set forth in claim 1, wherein a cover selectively closes said connector.

3. The remote keyless entry component as set forth in claim 1, wherein said connector is a USB connector.

4. A vehicle access system comprising:
a vehicle having a plurality of ports with locks, and a vehicle docking station communicating over a bus to an electronic control module on the vehicle;
a remote keyless entry system including a plurality of switches to actuate signals to be transmitted to a vehicle to provide at least the function of unlocking a port on the vehicle, and a transmitter for transmitting said signals from a location remote from said vehicle, said remote keyless entry component having a connector for connecting said remote keyless entry component into a computer.

5. The system as set forth in claim 4, wherein a cover selectively closes said connector when said connector.

6. The system as set forth in claim 4, wherein said connector is a USB connector.

7. A method of providing information from a vehicle to a maintenance facility comprising the steps of:
(1) providing a remote keyless entry component having switches to actuate signals to be sent remotely to a vehicle to unlock doors associated with the vehicle, and providing said remote keyless entry component with a connector to plug said remote keyless entry component into both a docking station on the vehicle, and into a home computer;
(2) plugging said remote keyless entry component into said docking station on a vehicle and transmitting diagnostic information to said remote keyless entry component; and
(3) removing said remote keyless entry component and plugging said remote keyless entry component into a home computer, and transmitting said diagnostic information over said home computer to a remote maintenance facility.
